(19) United States
(12) Patent Application Publication
(10) Pub. No.: US 2009/0159627 A1
(43) Pub. Date: Jun. 25, 2009

(54) Portable hitch mounted cargo carrier

(76) Inventor: Lee Myrex, Bremen, AL (US)

Correspondence Address: BUSH INTELLECTUAL PROPERTY LAW GROUP, LLC, P.O. BOX 381146, BIRMINGHAM, AL, 35238, US

(21) Appl. No.: 11/250,898

(22) Filed: Oct. 14, 2005

(51) Int. Cl. B60R 9/06; B60R 9/00

(52) U.S. Cl. 224/495; 224/519

(57) ABSTRACT

A cargo carrier having a hitch sleeve on its bottom and legs with wheels on its sides. A hitch shaft is inserted into a trailer hitch on a vehicle and the hitch sleeve fits over the hitch shaft. The legs have an internal screw type jack mechanism to raise and lower the cargo carrier to place the hitch sleeve over the hitch shaft, and to raise the legs so that the vehicle can transport the cargo carrier on the hitch shaft without having to remove the legs. The wheels allow the cargo carrier to be portable when not connected to the vehicle and allow the hitch sleeve to be aligned with the hitch shaft to facilitate insertion of bolts through the hitch sleeve and hitch shaft, thereby fastening the cargo carrier to the hitch shaft. The legs can be rotatably mounted to the cargo carrier to provide additional clearance of the legs above the ground by rotating them, once the cargo carrier hitch sleeve is connected to the hitch shaft inserted in the vehicle trailer hitch.

### BACKGROUND OF THE INVENTION

1. Field of the Invention

The present invention relates to cargo carriers which can be reversibly hitched to the rear of a vehicle, and, more particularly to a cargo carrier with rotatably mounted legs with wheels that have an internal screw type jack to raise and lower the cargo carrier.

2. Technical Background

Cargo carriers are known which have a hitch sleeve on the bottom of the carrier and a trailer hitch shaft which can be inserted into a receiver style trailer hitch on a vehicle. The trailer hitch shaft can also be inserted into the hitch sleeve on the bottom of the carrier. These carriers have no convenient means for lifting or moving the carrier. Other cargo carriers are known which also have legs with wheels where the legs can be raised and lowered by hand. Although these types of cargo carriers can be transported on their wheels, they are difficult to raise and lower by hand if they are heavy. Still other cargo carriers are known which also have rotatable legs with wheels which can be rotated up off the ground when the cargo carrier is attached to a vehicle, but the legs are not height-adjustable. In order to overcome some of these limitations, cargo carriers have been constructed with jacks that have wheels so that a cargo carrier with a heavy load can be easily raised and lowered and also be moved from one location to another on its own wheels. However, the jacks with wheels have to be removed from the cargo carrier after it has been hitched to a vehicle. In addition, the jack mechanism in these jacks is exposed to the external environment which can promote fouling and/or corrosion of the jack mechanism.

### SUMMARY OF THE INVENTION

The portable cargo carrier of the present invention has a hitch sleeve centered on its bottom and a hitch shaft which can be inserted into a receiver style trailer hitch on a vehicle, and into the hitch sleeve on the bottom of the cargo carrier. The cargo carrier also has four legs with casters and wheels, thereby making the carrier portable. The legs have a telescopic construction so that they can be lengthened or shortened by a screw type jack mechanism. The jack mechanism is contained within the legs, thereby protecting the jack mechanism. The jack provides a means for secure, easy, and precise raising and lowering of the cargo carrier, even with loads up to 800 pounds. The legs are rotatably attached to the carrier so that they can be rotated off the ground when the carrier is hitched to a vehicle, allowing the legs to remain on the carrier while the carrier is being transported by a vehicle.

An advantage of the present invention is a cargo carrier that can be easily raised or lowered by screw type jacks to hitch the carrier to a vehicle.

Another advantage is a cargo carrier that has wheels which allow the carrier to be easily transported from one location to another.

Another advantage is a cargo carrier that has legs with wheels and screw type jacks, where the legs are rotatable, thereby permitting the legs to remain on the carrier when the carrier is hitched to a vehicle.

Another advantage is a cargo carrier that is easy to hitch to a vehicle.

Another advantage is a cargo carrier that is simple and inexpensive to manufacture.

### BRIEF DESCRIPTION OF THE DRAWINGS

FIG. 1 shows a front view of the portable hitch mounted cargo carrier of the present invention.

FIG. 2 shows a hitch shaft inserted into a receiver style trailer hitch on a vehicle.

FIG. 3 shows the cargo carrier elevated by the jack mechanisms in the legs so that the hitch sleeve will fit over the hitch shaft and the carrier can be pushed towards the vehicle.

FIG. 4 shows the cargo carrier pushes towards the vehicle and the legs rotated upwards so that the cargo carrier can be transported by the vehicle.

FIG. 5 shows a perspective view of the hitch sleeve which is attached on the bottom of the cargo carrier.

FIG. 6 shows the features of the cargo carrier legs in more detail.

FIG. 7 shows the features of the screw type jack inside the cargo carrier legs in more detail.

FIG. 8 shows the cargo carrier sleeve base and leg clamp frame in more detail.

### DETAILED DESCRIPTION OF THE INVENTION

While the following description details the preferred embodiments of the present invention, it is to be understood that invention is not limited in its application to the details of construction and arrangement of the parts illustrated in the accompanying drawings, since the invention is capable of other embodiments and of being practiced in various ways.

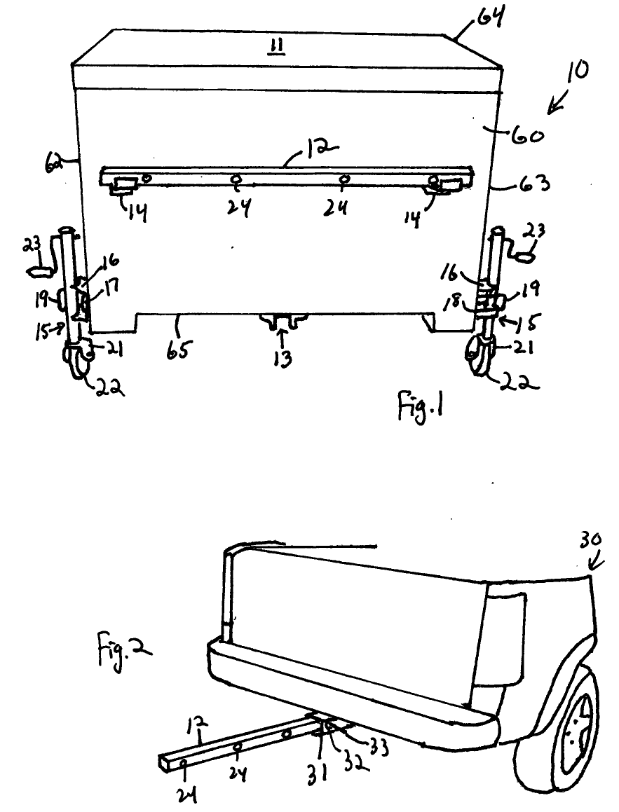

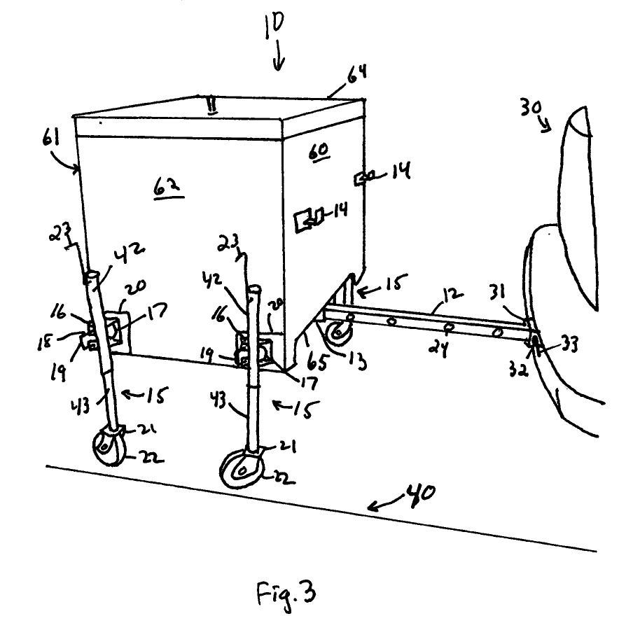

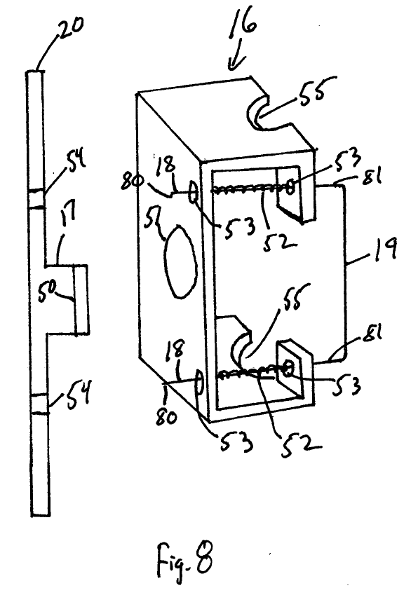

The cargo carrier 10 of the present invention is shown in FIG. 1. The cargo carrier 10 has a front 60, a back 61 (see FIG. 3), a left side 62, a right side 63, a top 64, and a bottom 65. Top 64 is constructed as a lid 11. Front 60 has a pair of hitch shaft holders 14 to hold hitch shaft 12 when cargo carrier 10 is not hitched to a vehicle. Bottom 65 has a hitch sleeve 13 centered on bottom 65. Left side 62 and right side 63 each have a pair of telescoping legs 15 and sleeves 17. Each leg has a clamp frame 16 which is fixed rotatably to sleeve 17. Clamp frame 16 has locking pins 18 (see FIG. 8) which form locking pin handle 19. Legs 15 have casters 21 with wheels 22. Legs 15 also have a jack handle 23 which operates a screw type jack 44 (see FIG. 7) to raise and lower legs 15. Hitch shaft 12 has holes 24 to reversibly attach hitch shaft 12 to hitch sleeve 13 and to a trailer hitch 31 on a vehicle 30 (see FIG. 2).

FIG. 2 shows hitch shaft 12 inserted into vehicle trailer hitch 31 on vehicle 30. Vehicle trailer hitch 31 has a hole 32 which can be aligned with a hitch shaft hole 24. A locking bolt 33 can be inserted through holes 32 and 24 to hold hitch shaft 12 firmly in place in vehicle trailer hitch 31.

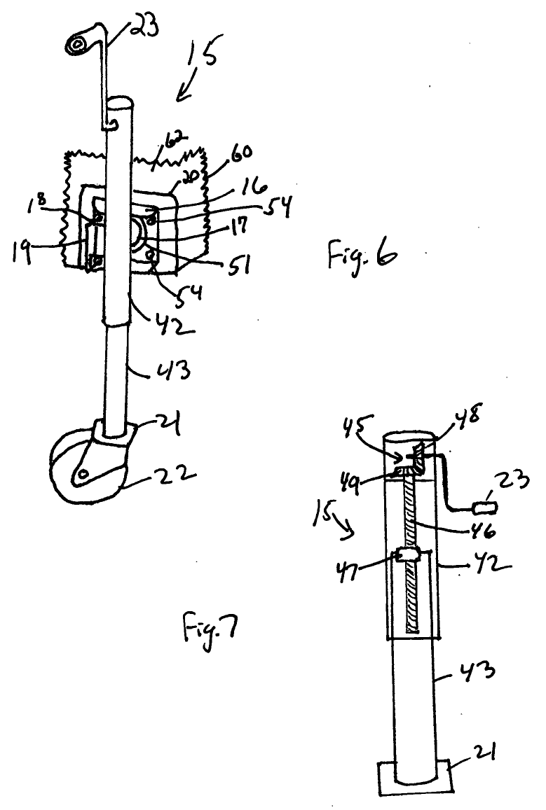

FIG. 3 illustrates the telescoping feature of legs 15. Legs 15 have a lower portion 43 which fits slideably into upper leg portion 42. Jack handle 23 can be rotated to operate a screw type jack 44 inside the upper 42 and lower 43 portions of leg 15 (see FIG. 7). Screw type jack 44 can extend lower leg portion 43 out of upper leg portion 42, thereby increasing the length of leg 15. Screw type jack 44 can withdraw lower leg portion 43 into upper leg portion 42, thereby shortening the length of leg 15. Cargo carrier 10 can be raised by increasing the length of legs 15 and lowered by decreasing the length of legs 15. FIG. 3 shows that legs 15 have been lengthened to raise cargo carrier 10 so that hitch sleeve 13 fits over hitch shaft 12. Cargo carrier 10 can be pushed forward on the ground 40 towards vehicle 30 so that hitch sleeve 13 moves over hitch shaft 12 and hitch shaft holes 24 align with holes 41 in hitch sleeve 13 (see FIG. 5). Locking bolts 33 can be inserted through holes 24 and 41 to hold hitch shaft 12 firmly in place in hitch sleeve 13. In this manner cargo carrier 10 can be securely attached to vehicle 30. FIG. 3 also shows a sleeve base 20 attached to cargo carrier 10. Sleeve base 20 has a sleeve 17. Clamp frame 16 fits rotatably on sleeve 17, thereby rotatably fixing legs 15 to cargo carrier 10.

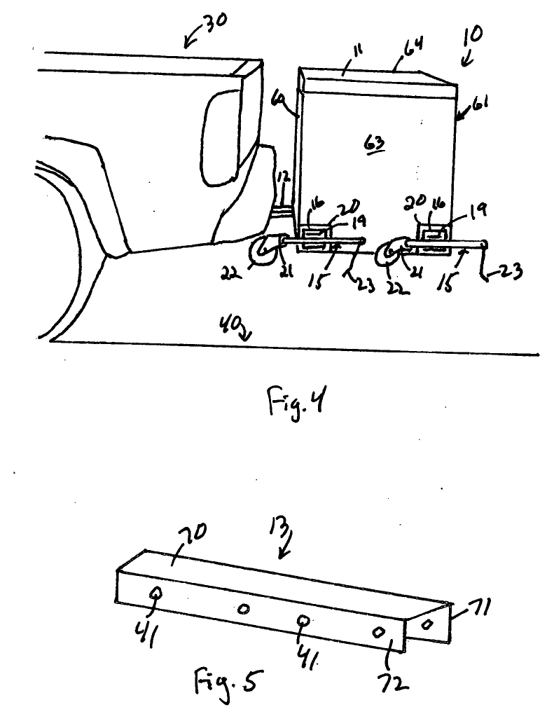

FIG. 4 shows cargo carrier 10 pushed towards vehicle 30. The lower portions 43 of legs 15 have been withdrawn into upper portions 42 of legs 15, and legs 15 have been rotated upward off the ground 40. Cargo carrier 10 can now be safely transported by vehicle 30. Cargo carrier 10 can be removed from vehicle 30 by rotating the legs 15 toward the ground and operating the jack 44 to lower the lower leg portions 43 to the ground 40 so that wheels 22 touch ground 40. Bolts 33 can be removed from holes 24, 32, and 41, and cargo carrier 10 can be pulled away from vehicle 30 so that hitch sleeve 13 comes off of hitch shaft 12. Hitch shaft 12 can be removed from trailer hitch 31 and placed into hitch shaft holders 14. Cargo carrier 10 can then be moved on its wheels 22 to any desired location.

FIG. 5 illustrates the features of hitch sleeve 13. Hitch sleeve 13 has a top 70, a right side 71, a left side 72 and holes 41. Hitch sleeve 13 is constructed to fit over hitch shaft 12 so that holes 41 align with holes 24 in hitch shaft 12. Top 70 of hitch sleeve 13 is attached to bottom 65 of carrier 10, preferably in the center of bottom 65.

FIG. 6 shows the features of leg 15 in more detail. Sleeve base 20 is fixed to cargo carrier 10. Sleeve base 20 has a sleeve 17 extending outward from base 20. Clamp frame 16 fits rotatably over sleeve 17. Clamp frame 16 is fixed to leg 15 so that leg 15 is thereby fixed rotatably to sleeve 17. Clamp frame 16 has a locking pin mechanism whereby locking pins 18 fit into locking pin holes 54 in sleeve base 20, thereby keeping legs 15 in a locked position. Pulling outward on locking pinhandle 19 withdraws the locking pins 18 from locking pin holes 54, and legs 15 can then be rotated to any desired position.

FIG. 7 shows the features of screw type jack 44 in more detail. Upper portion 42 of leg 15 has a handle 23 inserted into upper portion 42. The part of handle 23 inside upper portion 42 has a gear 48 which engages a gear 49, forming a worm gear 45. Gear 49 is attached to one end of a threaded screw shaft 46. The opposite end of the threaded screw shaft 46 engages a threaded nut 47 at the top of lower leg portion 43. As handle 23 is rotated the worm gear 45 causes the screw shaft 46 to rotate, screwing the screw shaft 46 into or out of threaded nut 47, depending on which direction the handle 23 is rotated. As screw shaft 46 is screwed into threaded nut 47, lower leg portion 43 is withdrawn into upper leg portion 42. As screw shaft 46 is screwed out of threaded nut 47, lower leg portion 43 is extended out of upper leg portion 42. This screw type jack 44 allows several hundred pounds to be easily raised or lowered in cargo carrier 10. These kinds of screw type jacks are known and can be purchased from Harbor Freight Tools, Birmingham, Ala.

FIG. 8 shows the features of clamp frame 16 and sleeve base 20 in more detail. Sleeve base 20 is fixed to cargo carrier 10, preferably on the sides 62 and 63 near bottom 65. Sleeve base 20 has a sleeve 17 which extends outward. Sleeve 17 has a snap ring groove 50 to lock clamp frame 16 rotatably onto sleeve 17 by means of a snap ring (not shown). Sleeve base 20 has a plurality of locking pin holes 54 for receiving locking pins 18 to lock clamp frame 16 in position.

Clamp frame 16 has contours 55 constructed to fit around upper leg portion 42 so that clamp frame 16 can be welded to upper leg portion 42. Clamp frame 16 also has a hole 51 constructed to fit over-sleeve 17 so that-clamp frame 16 can rotate around sleeve 17. Clamp frame 16 has holes 53 to accommodate locking pins 18. Locking pins 18 have first ends 80 which fit into locking pin holes 54. Locking pins 18 have opposite ends 81 which are continuous to form locking pin handle 19. Locking pins 18 have springs 52 which bias locking pins 18 into locking pin holes 54 on sleeve base 20. Locking pins 18 can be removed from locking pin holes 54 by pulling on locking pin handle 19. Thus, by pulling on locking pin handle 19, legs 15 can be rotated to any desired position. When locking pins 18 are aligned with any given pair of locking pin holes 54, legs 15 can be locked into a desired position by releasing locking pin handle 19. In this manner, legs 15 can be rotated upward towards the cargo carrier 10 or downward towards the ground 40.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention. For example, legs 15 can be mounted inside cargo carrier 10 so that lower leg portions 43 are able to extend through holes in the bottom 65 of carrier 10, and jack handle 23 extends through the side of cargo carrier 10. Legs 15 can be mounted on the front 60 and back 61 of carrier 10. The components of the present invention can be made of metal, plastic, or a combination thereof. A single handle can be constructed to operate all the jack mechanisms simultaneously by connecting all the gears 48 with shafts. The jacks can be powered with electric motors.

It will be understood that various changes in the details, materials, and arrangements of the parts which have been described and illustrated above in order to explain the nature of this invention may be made by those skilled in the art without departing from the principle and scope of the invention as recited in the following claims.

1. A cargo carrier, comprising:
a) a top having a lid, sides having legs, and a bottom having a U-shaped hitch sleeve;
b) a hitch shaft being reversibly connectable to a trailer hitch on a vehicle;
c) said legs having wheels so that said U-shaped hitch sleeve is alignable over said hitch shaft and so that said cargo carrier is portable when not connected to said vehicle
d) said legs having a jack mechanism to lower said cargo carrier to place said U-shaped hitch sleeve around said hitch shaft, and to raise said legs so that said vehicle can transport said cargo carrier on said hitch shaft; and
e) said U-shaped hitch sleeve being reversibly connectable to said hitch shaft by one or more bolts inserted horizontally through said U-shaped hitch sleeve and said hitch shaft.

2. The cargo carrier of claim 1 wherein said legs have an upper portion and lower portion, said jack mechanism lengthening said leg by extending said lower portion of said leg out of said upper portion of said leg, and shortening said leg by withdrawing said lower portion of said leg into said upper portion of said leg.

3. The cargo carrier of claim 1 wherein said legs are attached rotatably to said cargo carrier.

4. The cargo carrier of claim 2 wherein said jack mechanism consists of a worm gear arrangement and a screw shaft inside said upper portion of said leg which moves said lower portion of said leg into and out of said upper portion of said leg as said jack mechanism is activated.

5. The cargo carrier of claim 3 wherein said legs have a clamp frame which fits rotatably on a sleeve of a sleeve base, said sleeve base being fixed to said cargo carrier.

6. The cargo carrier of claim 5 wherein said clamp frame has locking pins and said sleeve base has locking pin holes so that said clamp frame and said leg are held in a fixed position by said locking pins being reversibly inserted into said locking pin holes.

7-9. (canceled)

10. A cargo carrier, comprising:
a) a top having a lid, sides having legs, and a bottom having a U-shaped hitch sleeve;
b) a hitch shaft being reversibly connectable to a trailer hitch on a vehicle;
c) said legs having wheels so that said U-shaped hitch sleeve is alignable over said hitch shaft and so that said cargo carrier is portable when not connected to said vehicle;
d) said legs having a jack mechanism to lower said cargo carrier to place said U-shaped hitch sleeve around said hitch shaft, and to said hitch shaft raise said lens so that said vehicle can transport said cargo carrier on said hitch shaft;
e) said U-shaped hitch sleeve being reversibly connectable to said hitch shaft by one or more bolts inserted horizontally through said U-shaped hitch sleeve and said hitch shaft; and
f) said legs having an upper portion and lower portion, said jack mechanism lengthening said leg by extending said lower portion of said leg out of said upper portion of said leg, and shortening said Leg by withdrawing said lower portion of said leg into said upper portion of said leg.

11. The cargo carrier of claim 10 wherein said legs are attached rotatably to said cargo carrier.

12. The cargo carrier of claim 10 wherein said jack mechanism consists of a worm gear arrangement and a screw shaft inside said upper portion of said leg which moves said lower portion of said leg into and out of said upper portion of said leg as said jack mechanism is activated.

13. The cargo carrier of claim 11 wherein said legs have a clamp frame which fits rotatably on a sleeve of a sleeve base, said sleeve base being fixed to said cargo carrier.

14. The cargo carrier of claim 13 wherein said clamp frame has locking pins and said sleeve base has locking pin holes so that said clamp frame and said leg are held in a fixed position by said locking pins being reversibly inserted into said locking pin holes.

15-16. (canceled)

17. A cargo carrier, comprising:
a) a top having a lid, sides having legs, and a bottom having a U-shaped hitch sleeve;
b) a hitch shaft being reversibly connectable to a trailer hitch on a vehicle;
c) said legs having wheels so that said U-shaped hitch sleeve is alignable over said hitch shaft and so that said cargo carrier is portable when not connected to said vehicle;
d) said legs having a jack mechanism to lower said cargo carrier to place said U-shaped hitch sleeve around said hitch shaft, and to raise said legs so that said vehicle can transport said cargo carrier on said hitch shaft;
e) said U-shaped hitch sleeve being reversibly connectable to said hitch shaft by one or more bolts inserted horizontally through said U-shaped hitch sleeve and said hitch shaft; and
f) said legs being attached rotatably to said cargo carrier, wherein said legs have a clamp frame which fits rotatably on a sleeve of a sleeve base, said sleeve base being fixed to said cargo carrier.

18. The cargo carrier of claim 17 wherein said legs have an upper portion and lower portion, said jack mechanism lengthening said leg by extending said lower portion of said leg out of said upper portion of said leg, and shortening said leg by withdrawing said lower portion of said leg into said upper portion of said leg.

19. The cargo carrier of claim 18 wherein said jack mechanism consists of a worm gear arrangement and a screw shaft inside said upper portion of said leg which moves said lower portion of said leg into and out of said upper portion of said leg as said jack mechanism is activated.

20. The cargo carrier of claim 17 wherein said clamp frame has locking pins and said sleeve base has locking pin holes so that said clamp frame and said leg are held in a fixed position by said locking pins being reversibly inserted into said locking pin holes.

21-23. (canceled)

24. A cargo carrier, comprising:
a) a top having a lid, sides having legs, and a bottom having a U-shaped hitch sleeve;
b) a hitch shaft being reversibly connectable to a trailer hitch on a vehicle;
c) said legs having wheels so that said U-shaped hitch sleeve is alignable over said hitch shaft and so that said cargo carrier is portable when not connected to said vehicle;
d) said legs having a jack mechanism to lower said cargo carrier to place said U-shaped hitch sleeve around said hitch shaft, and to raise said legs so that said vehicle can transport said cargo carrier on said hitch shaft;
e) said U-shaped hitch sleeve being reversibly connectable to said hitch shaft by one or more bolts inserted horizontally through said U-shaped hitch sleeve and said hitch shaft;
f) said legs attached rotatably to said cargo carrier, wherein said legs have a clamp frame which fits rotatably on a sleeve of a sleeve base, said sleeve base being fixed to said cargo carrier; and
g) said legs having an upper portion and lower portion, said jack mechanism lengthening said leg by extending said lower portion of said leg out of said upper portion of said leg, and shortening said leg by withdrawing said lower portion of said leg into said upper portion of said leg.

25. The cargo carrier of claim 24 wherein said jack mechanism consists of a worm gear arrangement and a screw shaft inside said upper portion of said leg which moves said lower portion of said leg into and out of said upper portion of said leg as said jack mechanism is activated.

26. The cargo carrier of claim 24 wherein said clamp frame has locking pins and said sleeve base has locking pin holes so that said clamp frame and said leg are held in a fixed position by said locking pins being reversibly inserted into said locking pin holes.

27-28. (canceled)

29. A cargo carrier, comprising:
a) a top having a lid, sides having legs, and a bottom having a U-shaped hitch sleeve;
b) a hitch shaft being reversibly connectable to a trailer hitch on a vehicle;
c) said legs having wheels so that said U-shaped hitch sleeve is alignable over said hitch shaft and so that said cargo carrier is portable when not connected to said vehicle;
d) said legs having a jack mechanism to lower said cargo carrier to place said U-shaped hitch sleeve around said hitch shaft, and to raise said legs so that said vehicle can transport said cargo carrier on said hitch shaft;
e) said U-shaped hitch sleeve being reversibly connectable to said hitch shaft by one or more bolts inserted horizontally through said U-shaped hitch sleeve and said hitch shaft;
f) said legs attached rotatably to said cargo carrier, wherein said legs have a clamp frame which fits rotatably on a sleeve of a sleeve base, said sleeve base being fixed to said cargo carrier;
g) said legs having an upper portion and lower portion, said jack mechanism lengthening said leg by extending said lower portion of said leg out of said upper portion of said leg, and shortening said leg by withdrawing said lower portion of said leg into said upper portion of said leg;
h) said jack mechanism consisting of a worm gear arrangement and a screw shaft inside said upper portion of said leg which moves said lower portion of said leg into and out of said upper portion of said leg as said jack mechanism is activated; and
i) said clamp frame having locking pins and said sleeve base having locking pin holes so that said clamp frame and said leg are held in a fixed position by said locking pins being reversibly inserted into said locking pin holes.

30. (canceled)
